(19) United States
(12) Patent Application Publication
(10) Pub. No.: US 2012/0036355 A1
(43) Pub. Date: Feb. 9, 2012

(54) Method and system for encrypting and decrypting transaction in power network

(75) Inventors: Moon-Jong Jang, Daejeon (KR); Bok-Nam Ha, Daejeon (KR); Sung-Woo Lee, Daejeon (KR); Chang-Hoon Shin, Daejeon (KR); No-Hong Kwak, Daejeon (KR)

(73) Assignee: KOREA ELECTRIC POWER CORPORATION, Seoul (KR)

(21) Appl. No.: 12/895,356

(22) Filed: Sep. 30, 2010

(30) Foreign Application Priority Data
Aug. 9, 2010 (KR) 10-2010-0076354

(51) Int. Cl. H04L 9/00

(52) U.S. Cl. 713/160

(57) ABSTRACT

Disclosed herein is a method and system for universally encrypting and decrypting a transaction which is a functional unit in a power network, while reducing a system load. When a transmitting node encrypts a transaction, the serial number of the transaction corresponding to each piece of data included in the transaction is present, and data is selected either using a predetermined criterion or randomly, and is then encrypted. The transaction serial number is added to the encrypted data. A receiving node selects data to be decrypted using the transaction serial number or a predetermined criterion. Through this operation, encryption has been conducted from the standpoint of the transaction, but only part of the data is encrypted based on a probability from the standpoint of the data, so that a system load is reduced, thus enabling efficient encryption and decryption technologies to be implemented.

### CROSS REFERENCE TO RELATED APPLICATION

This application claims the benefit of Korean Patent Application No. 10-2010-0076354, filed on Aug. 9, 2010, entitled “Method for Encryption and Decryption of Transaction in Power Network and System Thereof”, which is hereby incorporated by reference in its entirety into this application.

### BACKGROUND OF THE INVENTION

1. Technical Field

The present invention relates to a technology for encrypting transmission and reception data and safely protecting systems against cyber attacks in a communication network between devices that constitute a power system having a form similar to that of an intelligent distribution automation system. Further, the present invention relates to an encryption and decryption technology that can also be applied to fields for strengthening cyber security in operating system networks in power system fields such as a Supervisory Control And Data Acquisition (SCADA) system, an Energy Management System (EMS), a Distribution Management System (DMS) and an Advanced Metering Infrastructure (AMI), each including a plurality of devices having a communication function to manage power systems.

2. Description of the Related Art

In the networks of power systems, security problems related to data that is transmitted or received over such a network have become the main issue. Recently, due to the development of smart grid business, a large amount of security target information has been being transmitted or received over a power network, and it is predicted that the amount of security target information will further increase in the future.

In the case of Korea, most power system network management systems are implemented using a structure in which a self-network is configured and external access is prohibited, so that only an authorized user is allowed to access the self-network, thus ensuring security from the standpoint of the physical level. This security scheme is the simplest and securest method, but it may have limitations as power systems will accommodate international standards and advance towards open-type systems in the future.

In spite of these limitations, in the case of Korea, interest in cyber security in power system network management systems is not yet relatively high. In contrast, in the case of the U.S. or Europe in which self-networks are not configured, research into fields related to cyber security has been actively conducted and activities of the related fields have been strengthened.

Such research abroad is not properly suited in some aspects to the actual conditions of Korean power systems which have configured exclusive networks. Accordingly, the necessity for security systems and methods in power networks, which are independently configured in Korea, or which include Korean-unique features and can then be utilized all over the world, has increased.

### SUMMARY OF THE INVENTION

An object of the present invention is to provide cyber security and a method thereof, which is implemented by taking into consideration the characteristics of a communication infrastructure that supports the power system network of Korea.

In detail, the present invention has been made keeping in mind the above problems occurring in the prior art, and an object of the present invention is to prevent the forgery or falsification of data, the reuse of data, the analysis of data structures based on data taping, etc. by selecting and encrypting only part of the data while a series of data required for the processing of a unit function called a transaction is being transmitted, thus further strengthening cyber security in a power network.

Another object of the present invention is to provide a technology that applies a security solution on a transaction basis and reduces encryption targets, with the result that a system load can be reduced, and which can be efficiently used especially for the case where a power communication network is implemented based on a wireless network as a case abroad.

In order to accomplish the above objects, a method of encrypting a transaction in a power network is performed by a transmitting node and encrypting a transaction, which includes one or more pieces of data, to transmit the transaction in a network of a power system network management system, the method of encrypting comprising initializing a serial number of the transaction; generating transmission data included in the transaction; determining whether the generated transmission data is encryption target transmission data either by using a predetermined encryption target selection criterion received from a sequence server, or randomly; if it is determined that the generated transmission data is encryption target transmission data, adding the transaction serial number to a header of the encryption target transmission data; encrypting the encryption target transmission data using an encryption code acquired from the transmitting node or an external server; transmitting the transmission data to a receiving node which receives the transaction; and incrementing the transaction serial number by a unit value after the transmitting of the transmission data.

The method may further include, after the incrementing, repeating the generating until the transaction terminates.

The transaction may be a functional unit which includes remote monitoring or terminal control performed by a central server or each terminal of the power system network management system.

A method of decrypting a transaction in a power network is a method performed by a receiving node and decrypting and executing a transaction, which includes one or more pieces of data, in a network of a power system network management system, the decryption and execution method comprising, initializing a serial number of the transaction; receiving reception data included in the transaction; determining whether the reception data is encrypted data, either by using a predetermined encryption target selection criterion received from a sequence server, or by checking via analysis whether a transaction serial number is present in a header of the reception data; if it is determined that the reception data is encrypted data, decrypting the encrypted reception data using a decryption code acquired from the receiving node, a transmitting node or an external server; extracting both the header of decrypted reception data and the reception data, and verifying whether the decrypted reception data is abnormal by using the transaction serial number included in the header of the extracted reception data; executing the decrypted reception data and remaining reception data other than the decrypted reception data; and incrementing the transaction serial number by a unit value after the execution of the decrypted reception data.

The method may further comprise, after the incrementing, repeating the receiving until the transaction terminates.

The verifying may be configured to verify whether the decrypted reception data is abnormal by determining whether the transaction serial number included in the header of the extracted reception data is identical to a current serial number of the transaction serial number incremented by the receiving node.

A system for encrypting and decrypting a transaction in a power network comprises, a transmitting node for transmitting one or more pieces of data included in a transaction by encrypting part of the one or more pieces of data in a network of a power system network management system; and a receiving node for selecting the encrypted part from reception data received from the transmitting node, and decrypting and executing the encrypted data, wherein the transmitting node includes a data generation unit for individually generating one or more pieces of transmission data included in the transaction; an encryption control unit for selecting the part of the one or more pieces of transmission data as encryption target data, either by using a predetermined encryption target selection criterion received from a sequence server, or randomly; an encryption unit for encrypting the selected encryption target data using an encryption code which is stored in the encryption unit or is received from an external server, and adding verification information to a header of the encrypted data; and a communication device for sending the transmission data.

The receiving node may comprise a data reception unit for receiving from the transmitting node the one or more pieces of data, which are included in the transaction and part of which have been encrypted, as the reception data; a decryption control unit for determining whether the reception data is encrypted data by using a predetermined encryption target selection criterion received from a sequence server, or for selecting encrypted reception data using the verification information included in the header of the reception data; a decryption unit for decrypting the selected encrypted reception data by acquiring a description code stored in the transmitting node or an external server; a data verification unit for extracting a header of decrypted reception data, and verifying whether the decrypted reception data is abnormal by using the verification information included in the extracted header of the reception data; and a data execution unit for executing the received one or more pieces of data.

The transmitting node may further comprise a transmission transaction management unit for initializing a serial number of the transaction when the transaction is initiated, and incrementing the transaction serial number by a unit value whenever sending transmission data.

The transmission transaction management unit may terminate generation of transmission data belonging to one transaction when the transaction terminates based on the transaction serial number.

The receiving node may further comprise a reception transaction management unit for initializing a serial number of a transaction when the transaction is initiated, and incrementing the transaction serial number by a unit value whenever reception data is executed.

The reception transaction management unit may terminate reception of data belonging to one transaction when the transaction terminates based on the transaction serial number.

The verification information may be a transaction serial number corresponding to the transmission or reception data.

The data verification unit may determine whether the transaction serial number included in the extracted header of the reception data is identical to a current serial number of the transaction serial number incremented by the reception transaction management unit, thus verifying whether the decrypted reception data is abnormal.

The transaction may be a functional unit which includes remote monitoring or terminal control performed by a central server or each terminal of the power system network management system.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a method of encrypting a transaction in a power network according to an embodiment of the present invention;

FIG. 2 is a flowchart showing a method of decrypting a transaction in a power network according to an embodiment of the present invention;

FIG. 3 is a diagram showing an example of the structure of a power network to which the present invention is applied;

FIG. 4 is a diagram showing the configuration of a system for encrypting and decrypting a transaction in a power network according to an embodiment of the present invention; and

FIG. 5 is a detailed flowchart showing an embodiment of a method of decrypting a transaction in a receiving node.

### DESCRIPTION OF THE PREFERRED EMBODIMENTS

Hereinafter, embodiments of a method and system for encrypting and decrypting a transaction in a power network according to the present invention will be described in detail with reference to the attached drawings. The following description is not intended to limit the accompanying claims of the present invention, and equivalent inventions for performing the same function as the present invention in addition to the above embodiments will also belong to the scope of the present invention.

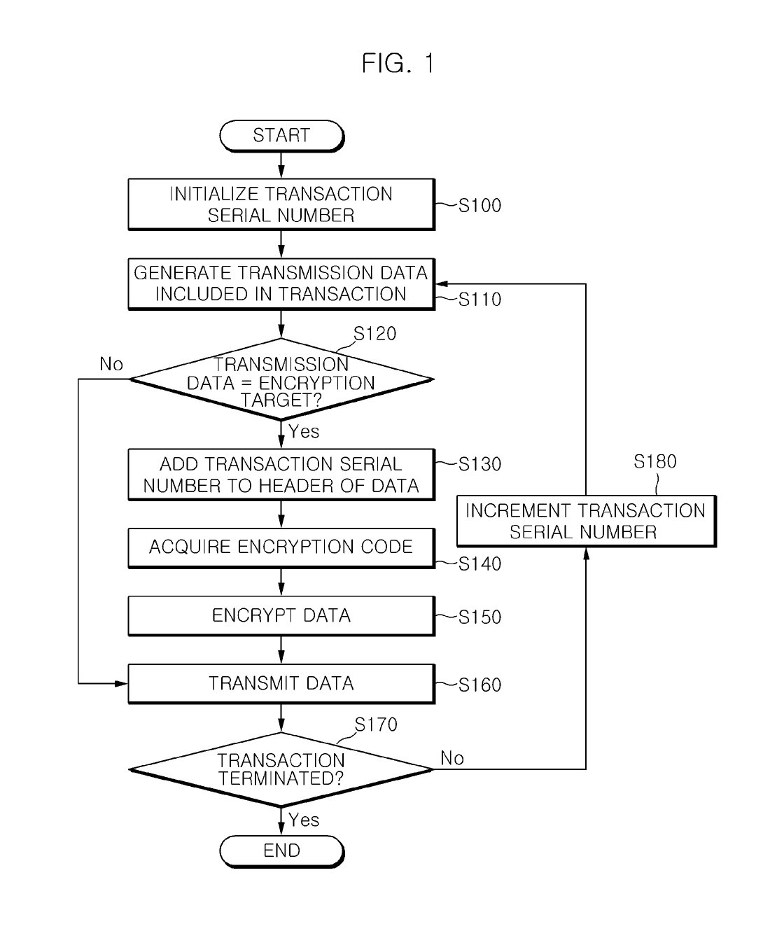

FIG. 1 is a flowchart showing a method of encrypting a transaction in a power network according to an embodiment of the present invention.

The present invention can be easily extended and applied not only to power systems having a form similar to that of an intelligent distribution automation system, but also to power system network management systems having similar functions and forms such as an SCADA system, an EMS, a DMS, and an AMI.

The present invention is applied to the case where data required for monitoring or control is mutually exchanged between a transmitting node and a receiving node over a power network when various types of functions of power systems having forms similar to that of an intelligent distribution automation system are performed between the transmitting node and the receiving node. In this case, a node corresponding to one of a central server and a terminal device, which desires to transmit data, is the transmitting node, and a node, which receives the transmitted data, is the receiving node.

The term ‘transaction’ refers to the unit of a series of detailed processes required to implement peculiar system functions which include remote monitoring or terminal control performed by the central server or each terminal of a power system network management system. Accordingly, a transaction may be composed of one data communication action or a plurality of data communication actions according to the process.

Referring to FIG. 1, individual steps of the transaction encryption method in the power network according to the embodiment of the present invention are performed by the transmitting node. First, step S100 at which the transmitting node initializes the serial number of the transaction is performed to transmit a transaction including one or more pieces of data in the network of the power system network management system.

The transaction serial number may also be used to count one or more pieces of data constituting one transaction. Further, a transaction serial number may be used to identify target data to be encrypted, which will be described later, or may be utilized as a means for determining whether the correct target data has been decrypted when encrypted data is decrypted. Therefore, the transmitting node initializes the transaction serial number whenever the transaction is initiated, and counts transaction serial numbers by the number of one or more pieces of data preset according to the transmitted transaction. After all of the data has been transmitted, that is, when the transaction serial number, incremented by a unit value per data transmission, has reached a preset threshold (different for each transaction) for the serial numbers of the transaction, the transmission of one transaction can terminate.

When the transaction serial number is initialized, the step S110 of generating transmission data included in the initiated transaction is performed. Step S110 may be the step at which the transmitting node receives previously generated transmission data included in one transaction, or the step of analyzing one transaction and then returning divided transmission data.

When the transmission data is generated, the transmitting node performs the step S120 of determining whether the generated transmission data is a target to be encrypted (encryption target).

In detail, step S120 may be the step of determining whether the generated transmission data is the encryption target, either randomly or by using a predetermined criterion which is used to select an encryption target (encryption target selection criterion) and which is received from a sequence server.

The sequence server may be provided, either separately in each system, or in the central server, and provides the criterion for determining whether to encrypt the generated transmission data. For example, when the last place of a data header has binary code, if the code is ‘0’, relevant transmission data is not selected as an encryption target, whereas if the code is ‘1’, the transmission data may be selected as the encryption target. Alternatively, transmission data, the transaction serial number of which ends with a specific number (for example, ‘1’), may be selected as the encryption target. The determination criterion of the sequence server is not limited to these examples, and any criterion can be used as long as it is a criterion for selecting part of one or more pieces of data constituting a transaction.

When the generated transmission data is selected as the encryption target at step S120, the transmitting node performs the step S130 of adding a current transaction serial number, that is, the serial number of the transaction at that time when the transmission data was generated, to the header of the selected transmission data so as to mark the encryption target.

After step S130 has been performed, the transmitting node performs the step S140 of acquiring an encryption code stored in the transmitting node or an external server, that is, a separate server which provides encryption and decryption codes, and the step S150 of encrypting the encryption target transmission data using the acquired encryption code.

That is, a predetermined mark is made on the selected encryption target transmission data, and resulting transmission data is encrypted, so that it is possible to encrypt only part of the data included in one transaction, on the basis of each transaction which is a set of a series of data, without encrypting all of the data that is transmitted or received over the power network. Accordingly, there is an advantage in that the load of the system can be greatly reduced.

If step S150 has been completed, or if it is determined that the generated transmission data is not an encryption target, that is, when the generated transmission data is not selected, the transmitting node performs the step S160 of transmitting transmission data, which is not the encryption target, or the encrypted transmission data, to the receiving node which will receive and perform the transaction.

In order to complete one transaction, one or more pieces of data must be generated and transmitted. Accordingly, the procedure for generating data, determining whether the generated data is an encryption target, and encrypting and transmitting data selected as an encryption target will be continuously repeated.

Therefore, steps S110 to S160 may be repeated until one transaction terminates.

Thereafter, the transmitting node may perform the step S170 of determining whether all of the one or more pieces of transmission data included in one transaction have been transmitted. As a result of the determination at step S170, if one transaction has terminated, the generation of transmission data is stopped, and a sequence of procedures terminates.

However, if it is determined that one transaction has not yet terminated, the transmitting node may perform the step S180 of incrementing the current transaction serial number by a unit value. Whenever one piece of data is generated and transmitted, the transmitting node may increment the transaction serial number, and may use the transaction serial number as a criterion for determining whether the transaction has terminated.

Furthermore, since different transaction serial numbers are added for respective pieces of transmission data which are the encryption targets, the transmitting node may transmit information about the transaction serial numbers corresponding to encrypted transmission data to the receiving node when the transmission of the transaction has been completed, thus allowing the receiving node to efficiently select data to be decrypted.

When one transaction has been encrypted by the above-described sequence of procedures, only part of the data included in the transaction is encrypted, but on the other hand the transaction is encrypted from the standpoint of the unit of one transaction. Accordingly, the present invention will obtain the effects of performing a cyber security function required for the power networks while reducing the load of the system.

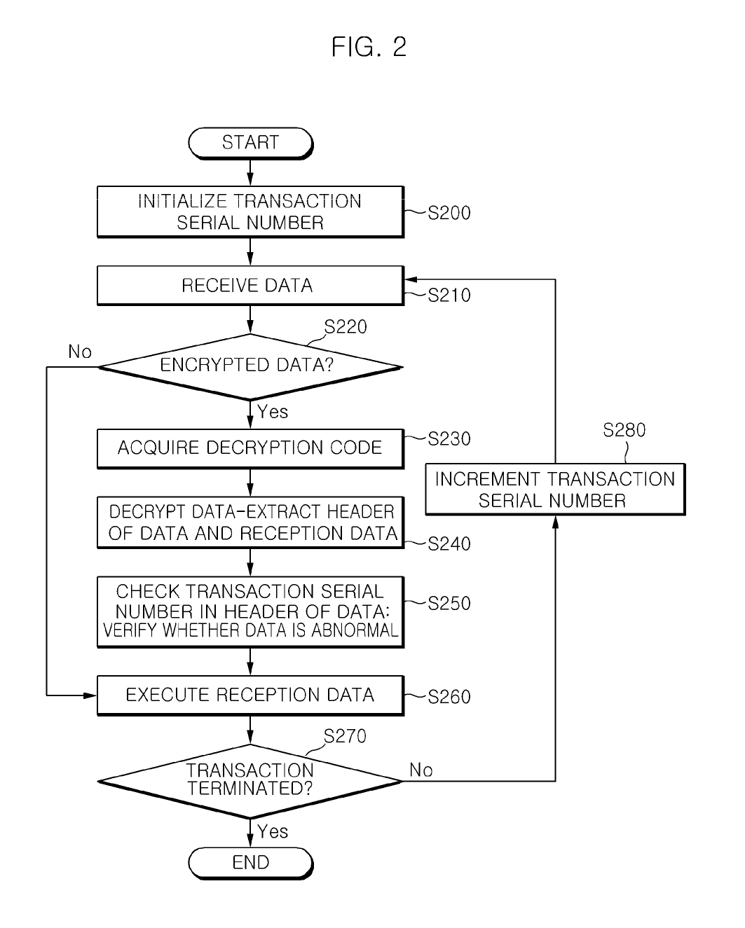

FIG. 2 is a flowchart showing a method of decrypting a transaction in a power network according to an embodiment of the present invention. A repetitive description of the same portion as that of FIG. 1 will be omitted hereunder.

Referring to FIG. 2, the transaction decryption method in the power network according to the embodiment of the present invention is performed by the receiving node. First, the receiving node performs the step S200 of, immediately before the reception of a transaction is initiated, initializing the serial number of a relevant transaction. The serial number of the transaction initialized by the receiving node may be identical to that of the transaction initialized by the transmitting node. Further, the increment (that is, the unit value) of the transaction serial number, which can be incremented by the receiving node which will be described later, may also be identical to that of the transaction serial number incremented at step S180.

When the transaction serial number is initialized by the receiving node, the receiving node performs the step S210 of receiving data which was encrypted based on a predetermined probability and is included in the transaction transmitted from the transmitting node. That is, step S210 is the step at which the receiving node individually receives one or more pieces of encrypted data which are included in the transaction.

The data received at step S210 may be reception data that is encrypted or not encrypted. In the network, it cannot be determined whether the transmitted data is encrypted data. Also in the network, the receiving node cannot determine whether the reception data is encrypted data without using a predetermined criterion or a predetermined determination method.

Therefore, after step S210, the step S220 of determining whether the reception data is encrypted data is performed. Step S220 may be the step of performing determination using a predetermined encryption target selection criterion received from a sequence server (this criterion is identical to the selection criterion at step S120 in the transmitting node of FIG. 1, which selects encryption target data so as to encrypt data included in the transaction corresponding to the reception data), or the step of checking whether a transaction serial number is present in the header of the reception data.

That is, the same criterion as that used by the transmitting node to select the encryption target is used by the receiving node, and thus encrypted reception data can be detected. Since the serial number of the transaction is added to the data header at step S130 of FIG. 1, whether a transaction serial number is present in the header of the reception data is checked, and thus the data with the transaction serial number present in the header may be selected as the encrypted reception data.

The header of the reception data in which the transaction serial number is present may also be encrypted. However, one or more pieces of data constituting the transaction may be sequentially received by the receiving node. Therefore, it is apparent that encrypted reception data may be detected by merely determining, with respect to the sequentially received data, whether the transaction serial number is present in the data headers of the received data.

If it is determined that the reception data is encrypted data at step S220, the receiving node performs the step S230 of acquiring a decryption code corresponding to the encryption code stored in the receiving node, the transmitting node or an external server. Thereafter, the receiving node performs the step S240 of decrypting the encrypted reception data using the decryption code. Step S240 may also include the step of extracting decrypted data and the header of the decrypted data.

After step S240 has been completed, the receiving node performs the step S250 of verifying whether the decrypted data is abnormal by using the transaction serial number, that is, a kind of verification information included in the header of the extracted reception data.

Step S250 may be, for example, the step of determining whether the decrypted data was obtained by decrypting data, which had been encrypted using the encryption code corresponding to the acquired decryption code, or whether the decrypted data was obtained by decrypting only the encrypted data. Step S250 may be, for example, the step of determining whether the transaction serial number included in the header of the extracted reception data is the current serial number of the transaction serial number which is incremented by the receiving node whenever data is executed.

Once step S250 has finished, if it is determined that the decrypted reception data is not abnormal, or if it is determined that the reception data is non-encrypted reception data, the receiving node performs the step S260 of immediately executing the reception data (or decrypted reception data).

Similarly to FIG. 1, steps S210 to S260 are repeated until one transaction terminates. The step S270 of determining whether the transaction has terminated is performed for such repetition. If it is determined that the transaction has terminated, the execution and reception of the entirety of the data terminate. In contrast, if it is determined that the transaction has not yet terminated, the serial number of the transaction is incremented by the unit value at step S280, and thereafter the step S210 of receiving data is performed again. When the serial number of the transaction is a serial number corresponding to the termination of the transaction, it can be determined that the transaction has terminated.

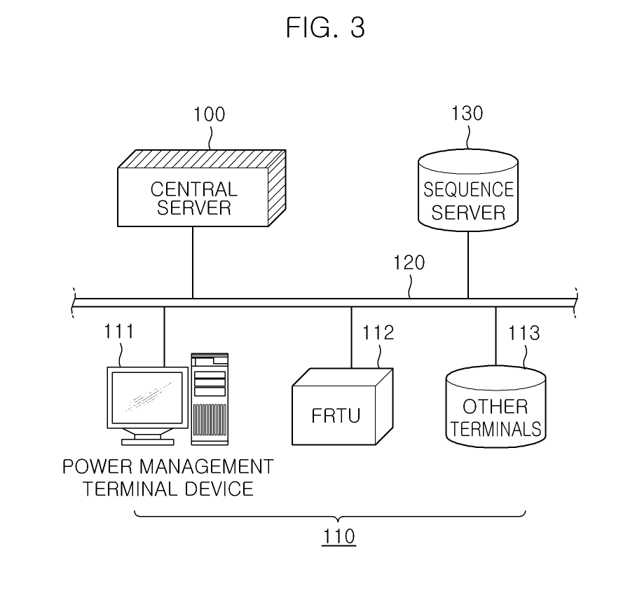

FIG. 3 is a diagram showing an example of the structure of a power network to which the present invention is applied.

Referring to FIG. 3, the power network to which the present invention is applied is a power system having a form similar to that of an intelligent distribution automation system. The power network typically includes a central server 100 for managing the entire system and terminal devices 110, 111, 112, and 113 scattered in a field along a distribution line, or in other places. The central server 100 and the terminal device 110 are connected to each other via a communication network 120. The communication network 120 includes all types of networks enabling the transmission/reception of data over a power network such as an optical line, a power line communication network, or a wireless network.

Further, a sequence server 130 for managing a predetermined criterion for selecting target data to be encrypted in the transmitting node and the receiving node may be independently provided. The sequence server 130 may perform the function of individually transmitting the criterion to the transmitting node and the receiving node, and may include a plurality of criteria. The sequence server 130 may transmit different selection criteria in real time, thus further strengthening security.

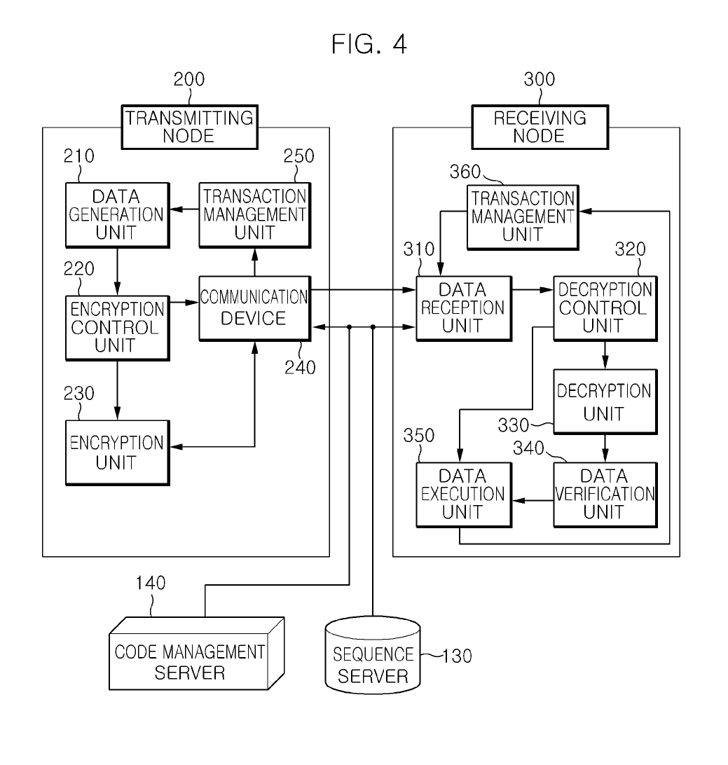

FIG. 4 is a diagram showing the configuration of a system for encrypting and decrypting a transaction in a power network according to an embodiment of the present invention. A repetitive description of the same portion as that of FIGS. 1 to 3 will be omitted hereunder.

Referring to FIG. 4, the system for encrypting and decrypting a transaction in a power network according to the embodiment of the present invention includes a transmitting node 200 and a receiving node 300. A sequence server 130 may be connected to a network, as described above.

A code management server 140 for managing codes may be separately provided. Typically, in the case of the network of a power system having a form similar to that of an intelligent distribution automation system, the central server 100 for managing the entire system may perform the function of the code management server 140. Basically, the distribution of encryption and decryption codes may be periodically performed. However, in special cases where an important control function is performed or where external invasion is sensed in the network, codes may be distributed at any time.

The transmitting node 200 includes a data generation unit 210 for generating one or more pieces of transmission data included in each transaction. The data generation unit 210 may generate transmission data per transaction serial number.

Further, the transmitting node 200 may include an encryption control unit 220 for selecting part of the one or more pieces of data as encryption target data, either by using a predetermined encryption target selection criterion received from the sequence server 130, or randomly.

The transmitting node 200 may include an encryption unit 230 for encrypting the transmission data which is the encryption target data selected by the encryption control unit 220, by using the encryption code which is stored in the encryption unit 230 or is received from the external code management server 140, and for adding verification information to the header of the encrypted data.

The verification information may be the transaction serial number corresponding to the currently generated transmission data, as shown in FIGS. 1 to 3. However, the verification information is not limited to this transaction serial number.

The transmitting node 200 may include a communication device 240 for sending transmission data that has been encrypted by the encryption unit 230, or data that was not selected as encryption target data and is included in the transaction.

The communication device 240 may include the functions of receiving the encryption target selection criterion and the relevant encryption code from the sequence server 130 and the code management server 140, respectively, in addition to the function of sending the data included in the transaction. Further, the communication device 240 may include the function of also transmitting the verification information added to the encrypted transmission data to the receiving node 300.

The transmitting node 200 may further include a transaction management unit 250. For convenience of description, the transaction management unit 250 is described as a transmission transaction management unit 250 in the accompanying claims so that it is distinguished from the transaction management unit 360 of the receiving node 300.

The transmission transaction management unit 250 functions to initialize the serial number of a transaction when the transaction is initiated, and to increment the transaction serial number by a unit value whenever encrypted transmission data, or transmission data which is other than the encrypted transmission data and is included in the transaction, is sent.

Further, the transmission transaction management unit 250 may include the function of terminating the generation of transmission data belonging to the transaction when the transaction serial number has reached the last number of all serial numbers of the transaction, that is, when one transaction has terminated.

That is, the transmission transaction management unit 250 functions to manage the transaction serial number when a signal indicating that one piece of data has been transmitted is transmitted from the communication device 240 or when a transaction request is received from the receiving node 300.

The receiving node 300 includes a data reception unit 310 for individually receiving one or more pieces of data, which are included in the transaction and part of which have been encrypted, from the transmitting node 200. The receiving node 300 may further include a decryption control unit 320 for determining whether the reception data received by the data reception unit 310 is encrypted data using a predetermined encryption target selection criterion received from the sequence server 130, or selecting encrypted reception data using verification information (that is, the transaction serial number) included in the header of the reception data.

If it is determined by the decryption control unit 320 that the reception data is encrypted data, the decryption unit 330 decrypts the encrypted reception data using a decryption code acquired from the transmitting node 200 or the external code management server 140.

The receiving node 300 may include a data verification unit 340 for extracting the header of the reception data decrypted by the decryption unit 330, and verifying whether the decrypted reception data is abnormal by using the verification information included in the extracted header of the reception data.

For example, the data verification unit 340 can verify whether the decrypted reception data is abnormal by determining whether the transaction serial number which is the verification information included in the extracted header of the reception data is identical to the current transaction serial number of the receiving node 300.

Therefore, the receiving node 300 may further include a transaction management unit 360 for initializing a transaction serial number when the reception of each transaction is initiated, and incrementing the transaction serial number by a unit value whenever data is executed by the data execution unit 350. The transaction management unit 360 is described as a reception transaction management unit 360 in the accompanying claims so that it is distinguished from the transmission transaction management unit 250.

The data execution unit 350 performs the function of executing the decrypted reception data, the abnormality or normality of which has been verified by the data verification unit 340, as described above.

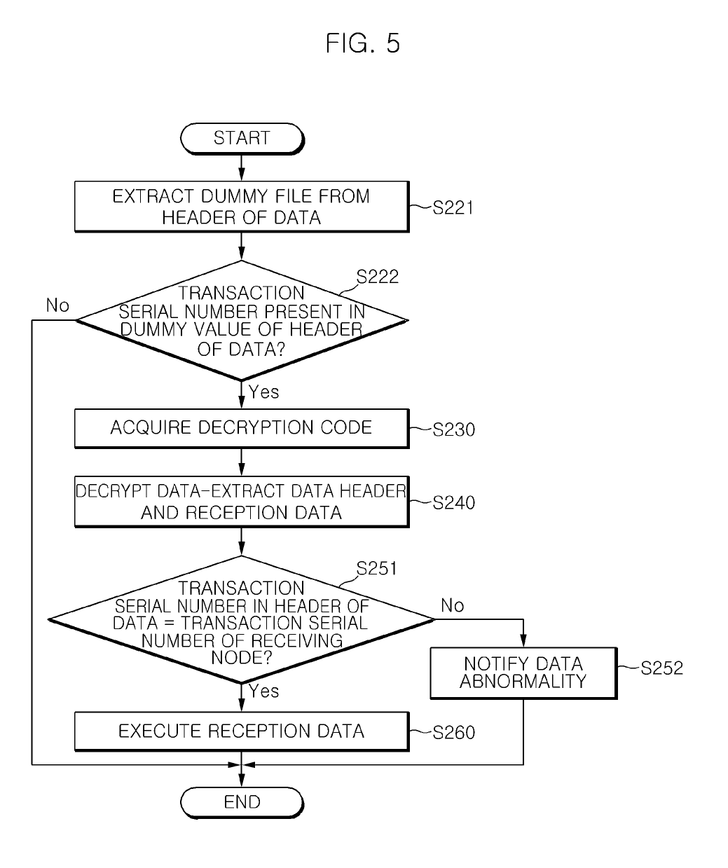

FIG. 5 is a detailed flowchart showing an embodiment of the method of decrypting a transaction in the receiving node. A repetitive description of the same portion as that of FIGS. 1 to 4 will be omitted hereunder. Further, for the sake of description, FIG. 2, together with FIG. 5, will also be referred to.

Referring to FIGS. 2 and 5, step S220 includes the step S221 of extracting the dummy file of the data header from the data received by the receiving node 300, and the step S222 of determining whether the serial number of the transaction is present in the extracted dummy value of the data header. Since the serial number of the transaction is added to the transmission data encrypted by the transmitting node 200 as described above, the serial number of the transaction is used when the reception data to be decrypted is selected.

Thereafter, when the decrypted data header and the decrypted reception data are extracted at steps S230 and S240, the receiving node 300 performs the step S251 of determining whether the transaction serial number included in the data header (for example, in the dummy value) is identical to the transaction serial number of the receiving node 300.

If it is determined at step S251 that the transaction serial numbers are not identical to each other, the decrypted data is determined to be abnormal, and thus the receiving node 300 may perform the step S252 of providing notification of the abnormality of the data. Step S252 may be the step of stopping reception of the entire transaction.

If it is determined at step S251 that the transaction serial numbers are identical to each other, the receiving node performs the step S260 of executing the decrypted reception data.

According to the present invention, the security of a power network can be carried out via the encryption of data, rather than via physical security, and thus there is an advantage in that such security may be commonly and internationally used. Further, the present invention is advantageous in that various encryption methods may be adopted, and encryption target data selection methods may also be differently selected for respective power systems, thus enabling the present invention to be widely applied to various fields.

Furthermore, the present invention is advantageous in that since only part of the data is encrypted based on a transaction which is one functional unit, and security is carried out for the entire transaction, the load of the system is reduced, so that a security system can be stably constructed even in a power network implemented in an inferior environment, thus enabling large effects to be expected from the standpoint of the range and stability of use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for encrypting a transaction by a transmitting node, in order to transmit the transaction which includes one or more pieces of data, in a network of a power system network management system, wherein the method for encrypting comprises:
initializing a transaction serial number;
generating transmission data included in the transaction;
determining whether the generated transmission data is encryption target transmission data either by using a predetermined encryption target selection criterion received from a sequence server, or randomly;
adding the transaction serial number to a header of the encryption target transmission data if it is determined that the generated transmission data is the encryption target transmission data;
encrypting the encryption target transmission data using an encryption code acquired from the transmitting node or an external server;
transmitting the transmission data to a receiving node which receives the transaction; and
incrementing the transaction serial number by a unit value after the transmitting of the transmission data.

2. The method for encrypting a transaction in a power network according to claim 1, further comprising, after the incrementing, repeating the generating until the transaction terminates.

3. The method for encrypting a transaction in a power network according to claim 1, wherein the transaction is a functional unit which includes remote monitoring or terminal control performed by a central server or each terminal of the power system network management system.

4. A method for decrypting and executing a transaction which includes one or more pieces of data, by a receiving node in a power network management system, wherein the method for decrypting and executing comprises:
initializing a transaction serial number;
receiving reception data included in the transaction;
determining whether the reception data is encrypted data, either by using a predetermined encryption target selection criterion received from a sequence server, or by checking via analysis whether a transaction serial number is present in a header of the reception data;
decrypting the encrypted reception data using a decryption code acquired from the receiving node, a transmitting node or an external server if it is determined that the reception data is encrypted data;
extracting both the header of decrypted reception data and the reception data, and verifying whether the decrypted reception data is abnormal by using the transaction serial number included in the header of the extracted reception data;
executing the decrypted reception data and reception data other than the decrypted reception data; and
incrementing the transaction serial number by a unit value after the executing.

5. The method for decrypting and executing a transaction in a power network according to claim 4, further comprising, after the incrementing, repeating the receiving until the transaction terminates.

6. The method for decrypting and executing a transaction in a power network according to claim 4, wherein the transaction is a functional unit which includes remote monitoring or terminal control performed by a central server or each terminal of the power system network management system.

7. The method for decrypting and executing a transaction in a power network according to claim 5, wherein the verifying is configured to verify whether the decrypted reception data is abnormal by determining whether the transaction serial number included in the header of the extracted reception data is identical to a current serial number of the transaction serial number incremented by the receiving node.

8. A system for encrypting and decrypting a transaction in a power network, comprising:
a transmitting node for encrypting part of one or more pieces of data included in a transaction and transmitting the one or more pieces of data in a network of a power system network management system; and
a receiving node for selecting the encrypted data from reception data received from the transmitting node, and decrypting and executing the encrypted data,
wherein the transmitting node comprises:
a data generation unit for individually generating one or more pieces of transmission data included in the transaction;
an encryption control unit for selecting the part of the one or more pieces of transmission data as encryption target data, either by using a predetermined encryption target selection criterion received from a sequence server, or randomly;
an encryption unit for encrypting the selected encryption target data using an encryption code which is stored in the encryption unit or is received from an external server, and adding a verification information to a header of the encrypted data; and
a communication device for sending the transmission data.

9. The system for encrypting and decrypting a transaction in a power network according to claim 8, wherein the receiving node comprises:
a data reception unit for receiving from the transmitting node the one or more pieces of data, which are included in the transaction and part of which have been encrypted, as the reception data;
a decryption control unit for determining whether the reception data is encrypted by using a predetermined encryption target selection criterion received from a sequence server, or for selecting encrypted reception data using the verification information included in the header of the reception data;
a decryption unit for decrypting the selected encrypted reception data by acquiring a description code stored in the transmitting node or an external server;
a data verification unit for extracting a header of decrypted selected reception data, and verifying whether the decrypted selected reception data is abnormal by using the verification information included in the extracted header of the reception data; and
a data execution unit for executing the received one or more pieces of data.

10. The system for encrypting and decrypting a transaction in a power network according to claim 8, wherein the transmitting node further comprises a transmission transaction management unit for initializing a transaction serial number when the transaction is initiated, and incrementing the transaction serial number by a unit value whenever sending transmission data.

11. The system for encrypting and decrypting a transaction in a power network according to claim 10, wherein the transmission transaction management unit terminates generation of transmission data belonging to one transaction when the transaction terminates based on the transaction serial number.

12. The system for encrypting and decrypting a transaction in a power network according to claim 9, wherein the receiving node further comprises a reception transaction management unit for initializing a transaction serial number when the transaction is initiated, and incrementing the transaction serial number by a unit value whenever reception data is executed.

13. The system for encrypting and decrypting a transaction in a power network according to claim 12, wherein the reception transaction management unit terminates reception of data belonging to one transaction when the transaction terminates based on the transaction serial number.

14. The system for encrypting and decrypting a transaction in a power network according to claim 9, wherein the verification information is a transaction serial number corresponding to the transmission or reception data.

15. The system for encrypting and decrypting a transaction in a power network according to claim 9, wherein the data verification unit verifies whether the decrypted reception data is abnormal, by determining whether a transaction serial number included in the extracted header of the reception data is identical to a current serial number of the transaction serial number incremented by a reception transaction management unit.

16. The system for encrypting and decrypting a transaction in a power network according to claim 8, wherein the transaction is a functional unit which includes remote monitoring or terminal control performed by a central server or each terminal of the power system network management system.
